(19) United States
(12) Patent Application Publication
(10) Pub. No.: US 2005/0288076 A1
(43) Pub. Date: Dec. 29, 2005

(54) Automatic/semiautomatic/manual sliding-type mobile communication terminal

(75) Inventor: Yong Cheol Seol, Kyungki-do (KR)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: Samsung Electro-Mechanics Co., Ltd., Suwon (KR)

(21) Appl. No.: 10/967,165

(22) Filed: Oct. 19, 2004

(30) Foreign Application Priority Data
Jun. 23, 2004 (KR) 2004-47303

(51) Int. Cl. H04M 1/00

(52) U.S. Cl. 455/575.4; 455/575.1

(57) ABSTRACT

Disclosed herein is a sliding-type mobile communication terminal that is capable of performing a sliding movement in an automatic/semiautomatic/manual mode. The sliding-type mobile communication terminal has a first terminal body and a second terminal body. The sliding-type mobile communication terminal comprises a driving unit, a power transmission unit, having one end connected to a rotary shaft of the driving unit and the other end securely fixed to the second terminal body, a cylindrical housing rotatably mounted in the second terminal body, first driving means fixed to one side of the housing, second driving means mounted in the first terminal body, and a driving control unit. The housing is rotated through the rotational restriction of the power transmission unit and the selective engagement of the engaging members, and the first driving means contacts the second driving means as the housing is rotated so that the sliding movement is carried out.

### RELATED APPLICATIONS

The present application is based on, and claims priority from, Korean Application Number 2004-0047303, filed Jun. 23, 2004, the disclosure of which is hereby incorporated by reference herein in its entirety.

### BACKGROUND OF THE INVENTION

1. Field of the Invention

The present invention relates generally to an automatic/semiautomatic/manual sliding-type mobile communication terminal, and more particularly to an automatic/semiautomatic/manual sliding-type mobile communication terminal comprising a driving unit, a pair of engaging members, which are selectively engageable with each other, driving means, and a sensor unit so that a first terminal body and a second terminal body are easily and smoothly slid relative to each other in an automatic/semiautomatic mode or an automatic/manual mode.

2. Description of the Related Art

Generally, a sliding-type mobile communication terminal has an upper terminal body and a lower terminal body. The upper terminal body and the lower terminal body are slid relative to each other while the upper terminal body is laid on the top of the lower terminal body so that the lower terminal body is exposed or covered.

The sliding-type mobile communication terminal comprises a slide module including guides securely fixed to one side of the mobile communication terminal for guiding a sliding movement, and sliders that perform a reciprocating sliding movement along the guides. The sliders are securely fixed to the other side of the mobile communication terminal, which is opposite to the side of the mobile communication terminal where the guides are securely fixed.

When the guides are provided at the rear part of the upper terminal body, for example, the sliders are attached to the front part of the lower terminal body in such a manner that the guides correspond to the sliders, whereby the sliders can perform a reciprocating sliding movement along the guides.

FIG. 1 is a rear view schematically showing a conventional sliding-type mobile communication terminal.

As shown in FIG. 1, the conventional sliding-type mobile communication terminal comprises an upper terminal body 110 having a display unit (not shown) disposed at the front part thereof, and a lower terminal body 120 having a battery pack 121 attached to the rear part thereof. The upper terminal body 110 and the lower terminal body 120 are slid relative to each other while the upper terminal body 110 is laid on the top of the lower terminal body 120 so that the lower terminal body 120 is exposed or covered. At the rear part of the upper terminal body 110 are formed guide slits 111, in which guides (not shown) for guiding a sliding movement are disposed, respectively. At one side of the front part of the upper terminal body 120 are attached sliders, which perform a reciprocating sliding movement along the guides, respectively. Consequently, the sliders can be slid along with the lower terminal body 120.

Between the guides and the sliders are disposed resilient means, such as coil springs or other suitable springs, which provide a restoring force in the direction of opening the mobile communication terminal while the mobile communication terminal is closed so that the mobile communication terminal can be manually opened.

However, the conventional sliding-type mobile communication terminal with the above-mentioned slide module has a drawback in that the sliding-type mobile communication terminal is not easily opened/closed as compared to a folder-type mobile communication terminal, and the mobile communication terminal is not easily opened/closed with one hand.

Therefore, an automatic sliding-type mobile communication terminal that eliminates the above-mentioned drawback has been increasingly requested in the art to which the present invention pertains.

Such a sliding-type mobile communication terminal that is capable of automatically performing an opening/closing operation of the sliding-type mobile communication terminal is shown in FIGS. 2A and 2B.

As shown in FIGS. 2A and 2B, the sliding-type mobile communication terminal comprises a pinion gear 145 attached to one end of a second terminal body 140, a rack 131 attached to one side of a first terminal body 130 in the longitudinal direction of the first terminal body 130 such that the rack 131 is engaged with the pinion gear 145, a driving motor (not shown) securely fixed to the second terminal body 140 for providing a driving force, a power transmission unit 150 for transmitting the driving force from the driving motor to the pinion gear 145, and a control switch 132 for controlling operation of the driving motor.

In the sliding-type mobile communication terminal as described above, the driving motor is operated through a user's manipulation of the control switch 132 while the second terminal body 140 is covered. As the driving motor is operated, the rotating force of the driving motor is transmitted to the pinion gear 145 via the power transmission unit 150. As a result, the pinion gear 145 is rotated, and therefore the rack 131 engaged with the pinion gear 145 is moved. Consequently, the first terminal body 130 is moved upward so that the second terminal body 140 is exposed.

With the conventional automatic sliding-type mobile communication terminal that is capable of performing a sliding movement through the use of the pinion gear 145 and the rack 131, the automatic sliding movement can be easily carried out. However, the mobile communication terminal is not easily opened/closed with one hand when the sliding movement is to be carried out manually, as in the above-described conventional manual sliding-type mobile communication terminal. In addition, the sliding-type mobile communication terminal is not fully opened/closed when an external force is applied to the sliding-type mobile communication terminal.

Furthermore, the rack 131 is formed at the rear surface of the first terminal body 130. As a result, the rack 131 is exposed while the sliding-type mobile communication terminal is opened, and thus the sliding-type mobile communication terminal is not provided with an aesthetically pleasing appearance.

With the conventional automatic sliding-type mobile communication terminal as described above, the operation of the driving motor is stopped a prescribed period of time after the rotating operation is initiated or after the driving motor is rotated by prescribed degrees to perform the automatic sliding movement. When the driving torque is changed or the driving force of the driving motor is changed, however, the full opening/closing operation of the sliding-type mobile communication terminal is not guaranteed. In the case that the rack and the pinion gear are not accurately engaged with each other, the first terminal body cannot be exactly moved upward from or downward to the second terminal body, and thus the sliding-type mobile communication terminal cannot be precisely opened/closed.

In order to solve the above-mentioned problem, there is needed position detecting means for detecting relative positions between the first terminal body and the second terminal body, whereby the first terminal body reaches a prescribed position where the first terminal body is fully opened or closed.

When the second terminal body is not fully exposed since an external force is applied to the sliding-type mobile communication terminal, current is continuously supplied to the motor with the result that the battery is quickly consumed. Also, an excessive load is applied to a driving system of the sliding-type mobile communication terminal, which may result in breakdown of the sliding-type mobile communication terminal. Consequently, a sliding-type mobile communication terminal that is capable of effectively returning to its original position is required.

### SUMMARY OF THE INVENTION

Therefore, the present invention has been made in view of the above problems, and it is an object of the present invention to provide an automatic/semiautomatic/manual sliding-type mobile communication terminal comprising a driving unit, a pair of engaging members, which are selectively engageable with each other, driving means, and a sensor unit so that a first terminal body and a second terminal body are easily and smoothly slid relative to each other in an automatic/semiautomatic/manual mode, whereby the sliding-type mobile communication terminal is more easily and smoothly opened/closed.

It is another object of the present invention to accomplish a full opening/closing operation of the sliding-type mobile communication terminal using the sensor unit.

It is another object of the present invention to provide a device for returning the sliding-type mobile communication terminal to its original position when the mobile communication terminal is not fully opened/closed since an external force is applied to the mobile communication terminal.

It is yet another object of the present invention to provide an automatic/semiautomatic/manual sliding-type mobile communication terminal having a slide module mounted therein, whereby the sliding-type mobile communication terminal is provided with an aesthetically pleasing appearance, and the assembly operation of the sliding-type mobile communication terminal is easy and convenient.

In accordance with one aspect of the present invention, the above and other objects can be accomplished by the provision of a sliding-type mobile communication terminal comprising: a first terminal body and a second terminal body, the first terminal body and the second terminal body being slid relative to each other while one of the first terminal body and the second terminal body is laid on the top of the other; wherein the mobile communication terminal comprises: a driving unit for providing power necessary for a sliding movement for opening/closing the mobile communication terminal; a power transmission unit, having one end connected to a rotary shaft of the driving unit in the axial direction and the other end securely fixed to the second terminal body, for transmitting a driving force of the driving unit or an external force through a pair of engaging members selectively engageable with each other by resilient means; a cylindrical housing rotatably mounted in the second terminal body, the housing receiving the power transmission unit therein, and fixing the driving unit therein so that a rotating axis of the housing is coaxial with the rotary shaft of the diving unit; first driving means fixed to one side of the housing for sliding the first terminal body when the housing is rotated; second driving means received in the first terminal body for contacting the first driving means so that the rotation movement of the first driving means is converted into the sliding movement of the first terminal body; and a driving control unit for controlling operation of the driving unit so that the sliding movement of the first terminal body is controlled, and wherein the housing is rotated through the rotational restriction of the power transmission unit and the selective engagement of the engaging members, and the first driving means contacts the second driving means as the housing is rotated so that the sliding movement is carried out.

Preferably, the power transmission unit comprises: a hinge shaft connected to the rotary shaft of the driving unit for transmitting the driving force of the driving unit; a slide cam selectively engageable with the hinge shaft every prescribed degrees; a guide cam for accommodating the slide cam; and resilient means for providing a resilient force necessary to selectively engage the hinge shaft with the slide cam. The pair of engaging members comprises the hinge shaft and the slide cam.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a rear view schematically showing a conventional sliding-type mobile communication terminal;

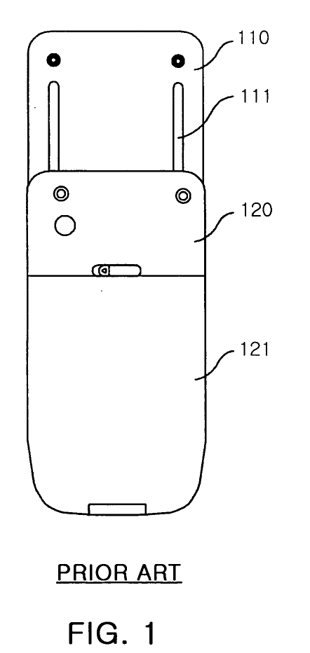

FIGS. 2A and 2B are views schematically showing a conventional automatic sliding-type mobile communication terminal;

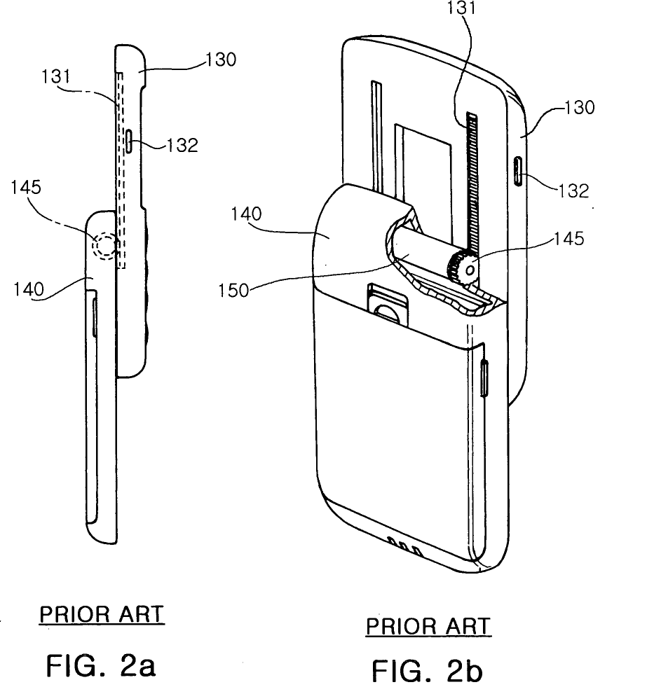

FIG. 3 is an exploded perspective view showing main components of a sliding-type mobile communication terminal according to the present invention;

FIGS. 4A and 4B are sectional views respectively showing an automatic/semiautomatic/manual operating principle of the sliding-type mobile communication terminal according to the present invention;

FIGS. 5A and 5B are plan and side views respectively showing the main components mounted in the sliding-type mobile communication terminal according to a preferred embodiment of the present invention;

FIGS. 6A and 6B are side views respectively showing the main components mounted in the sliding-type mobile communication terminal according to other preferred embodiments of the present invention; and

FIGS. 7A and 7B are side views respectively illustrating a fully closing/opening operation of the sliding-type mobile communication terminal with position detecting means for detecting relative positions between a first terminal body and a second terminal body according to the present invention.

### DESCRIPTION OF THE PREFERRED EMBODIMENTS

Now, preferred embodiments of the present invention will be described in detail with reference to the accompanying drawings.

The present invention relates to a sliding-type mobile communication terminal including two terminal bodies. Hereinafter, one of the terminal bodies, which is slid while contacting the other terminal body, is referred to as a first terminal body, and the other terminal body, which has a housing mounted therein, is referred to as a second terminal body. An upper terminal body of the sliding-type mobile communication terminal may be the first terminal body or the second terminal body depending upon whether the first terminal body or the second terminal body has the housing mounted therein.

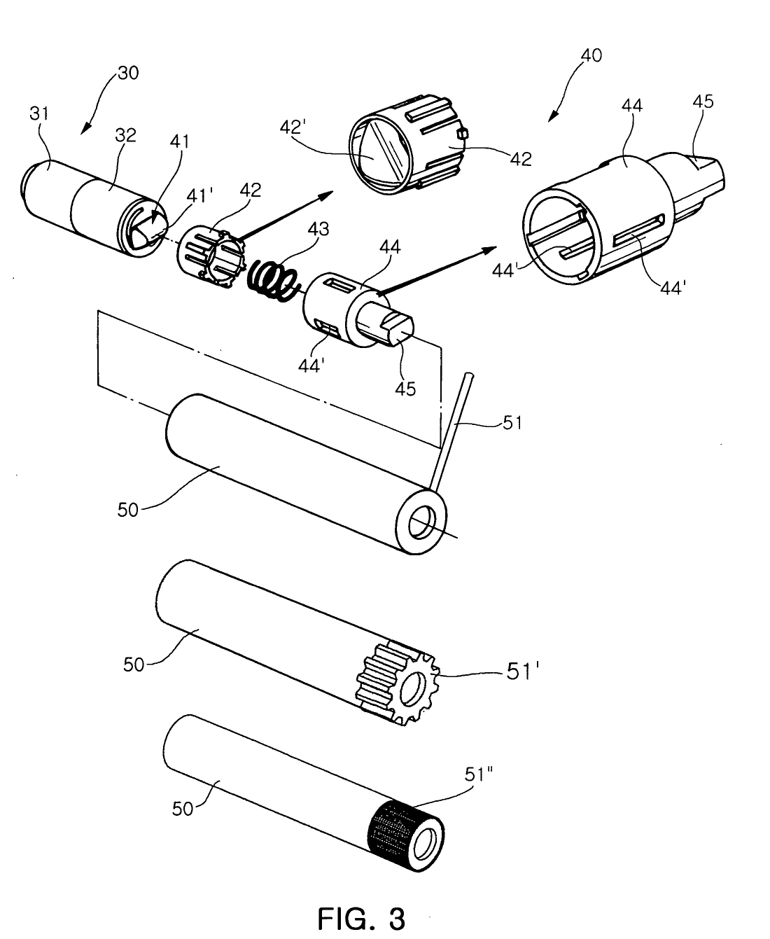

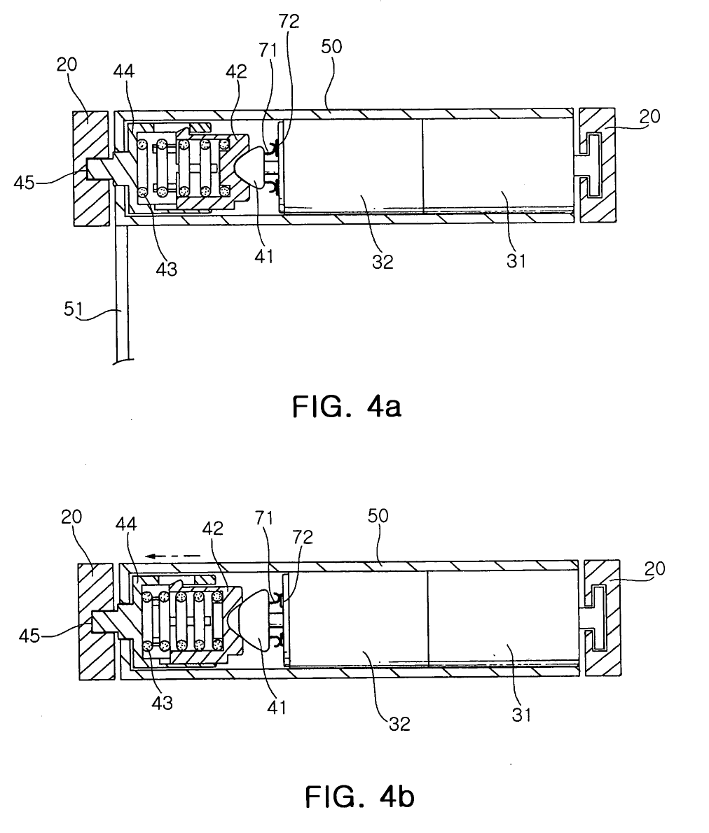

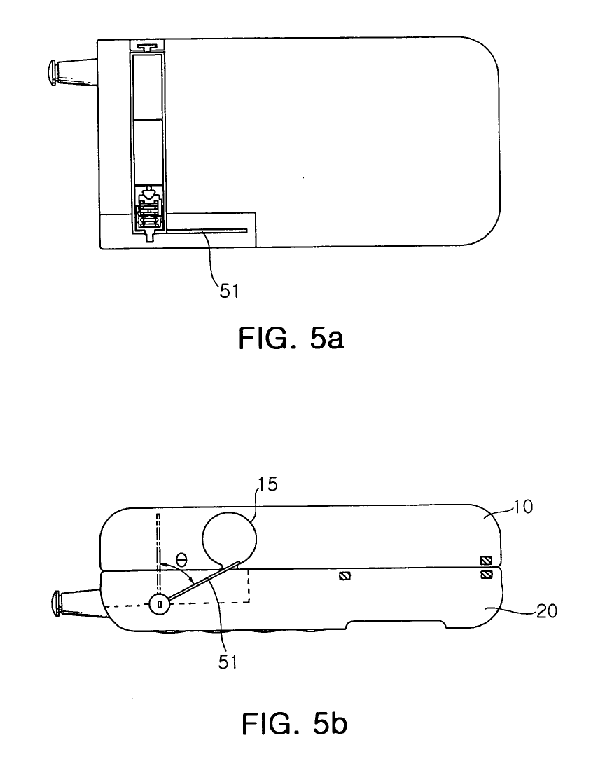

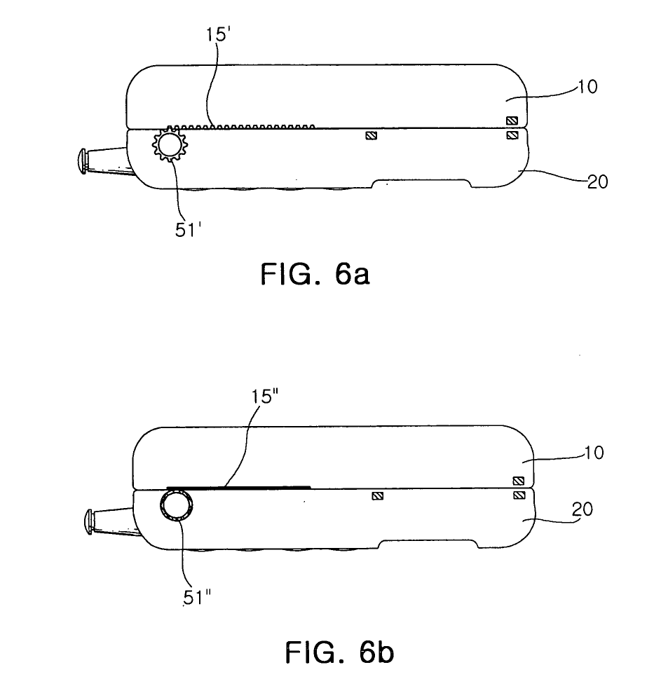

FIG. 3 is an exploded perspective view showing main components of a sliding-type mobile communication terminal according to the present invention, FIGS. 4A and 4B are sectional views respectively showing an automatic/semiautomatic/manual operating principle of the sliding-type mobile communication terminal according to the present invention, FIGS. 5A and 5B are plan and side views respectively showing the main components mounted in the sliding-type mobile communication terminal according to a preferred embodiment of the present invention, and FIGS. 6A and 6B are side views respectively showing the main components mounted in the sliding-type mobile communication terminal according to other preferred embodiments of the present invention.

The sliding-type mobile communication terminal according to the present invention includes a driving unit 30, a power transmission unit 40 connected to the rotary shaft of the driving unit 30 for transmitting a driving force of the driving unit 30, the power transmission unit 40 having a pair of engaging members selectively engageable with each other by resilient means, a housing 50 for accommodating the power transmission unit 40, first driving means 51 securely fixed to the housing 50, and second driving means 15 contacting the first driving means 51.

The sliding-type mobile communication terminal according to the present invention further includes a driving control unit (not shown) for controlling operation of the driving unit 30 to control a sliding movement of the first terminal body.

As shown in FIG. 3, the driving unit 30 serves to receive current from a battery mounted in the mobile communication terminal and to supply the power so that an automatic or semiautomatic sliding movement is carried out. The case of the driving unit 30 is fixed to the housing 50. As a result, the case of the driving unit 30 is rotated along with the housing 50.

Preferably, the driving unit 30 may be a motor, for example, a geared motor with a gearbox 32 disposed at the output side thereof. The gearbox 32 includes a planetary gear-type reducer having a reduction ratio of approximately 500 to 600:1 to amplify a driving torque. Consequently, the gearbox 32 serves to perform a reduction function and a reversion preventing function at the same time.

As shown in FIG. 3, the power transmission unit 40 includes a hinge shaft 41 securely fixed to the rotary shaft of the motor 31, a slide cam 42 selectively engageable with the hinge shaft 41, a guide cam 44 for accommodating the slide cam 42, and resilient means 43 for providing a resilient force necessary to selectively engage the slide cam 42 with the guide cam 44.

The hinge shaft 41 is securely fixed to the rotary shaft of the motor (or the geared motor) 31 such that the hinge shaft 41 can be rotated relative to the motor 31 when the motor 31 is operated. Specifically, if the rotation of the hinge shaft is restricted when the motor 31 is operated, the main body of the motor is rotated.

The slide cam 42 is selectively engaged with the hinge shaft 41 by means of the resilient force of the resilient means 43.

In the case of using a rotary bar, which will be described below, the sliding movement is completed when the rotary bar is rotated 180 degrees. Consequently, the hinge shaft 41 and the slide cam 42 are preferably engaged with each other every 180 degrees.

As shown in FIG. 3, the hinge shaft 41 is provided with a protrusion 41′, which is tapered so that the hinge shaft 41 serves as a male-type cam. The slide cam 42 is provided at one side thereof with a depression 42′, which corresponds to the protrusion 41′ of the male-type cam, so that the slide cam 42 serves as a female-type cam.

Alternatively, the hinge shaft 41 may serve as a female-type cam having a depression, and the slide cam 42 may serve as a male-type cam having a protrusion.

The slide cam 42 is disposed in the guide cam 44 in such a manner that the slide cam 42 can be locked in the rotating direction and moved in the axial direction.

Specifically, the guide cam 44 has key grooves 44′ formed at the circumference thereof, as shown in FIG. 3. The slide cam 42 is locked in the key grooves 44′. Consequently, the slide cam 42 is locked by means of the guide cam 44 in the rotating direction so that the slide cam 42 can be rotated along with the guide cam 44 when the guide cam 44 is rotated, and the slide cam 42 can be moved in the axial direction by the length of each key groove 44′.

A protrusion 45 formed at one end of the guide cam 44 is inserted through a through-hole formed through the housing 50 and fixed to the second terminal body, as shown in FIGS. 4A and 4B. Consequently, the rotation of the guide cam 44 and the slide cam 42 disposed in the guide cam 44 is restricted.

The slide cam 42 is selectively engaged with the guide cam 44 by the resilient means 43. Specifically, the resilient means 43 is disposed between the slide cam 42 and the guide cam 44 for pressing the slide cam 42 toward the hinge shaft 41. Preferably, the resilient means 43 is a compression coil spring.

Preferably, the resilient means 43 has a resilient force, which is larger than the driving force of the motor and smaller than an external force. In the case of an automatic/semiautomatic sliding movement, the resilient means 43 is expanded, as shown in FIG. 4A, so that the slide cam 42 is engaged with the hinge shaft 41. As a result, the motor is rotated. In the case of a manual sliding movement by means of the external force, on the other hand, the resilient means 43 is compressed, as shown in FIG. 4B, so that the slide cam 42 is disengaged from the hinge shaft 41.

In the case that a rotary bar is used as the first driving means 51, which will be described below, it is more preferable that the resilient means 43 be maximally compressed when the rotary bar 51 is perpendicular to a slide surface, and that the resilient means 43 be slightly compressed when the second terminal body is fully exposed or fully covered. As a result, the opening/closing movement of the first terminal body is not carried out when a very small external force is applied to the first terminal body. Consequently, the sliding-type mobile communication terminal can be very stably used.

As shown in FIGS. 4A and 4B, the motor 31 and the power transmission unit 40 are disposed in the housing 50. The motor 31 is fixed to the inside of the housing 50 so that the housing 50 is rotated along with the motor 31 when the motor 31 is rotated. The guide cam 44 is rotated relative to the housing 50.

Specifically, the housing 50 is rotated by means of the driving force of the motor 31 fixed to the inside of the housing 50 in the case of the automatic or semiautomatic operation, and the housing 50 is rotated by means of an external force applied to the first driving means 51 in the case of the manual operation.

As shown in FIG. 3, the first driving means 51 is securely fixed to a prescribed position of the outer circumference of the housing 50, which is adjacent to one end of the housing 50. The first driving means 51 contacts the second driving means 15 to slide the first terminal body as the housing 50 is rotated.

Preferably, the first driving means is a rotary bar 51 securely fixed to the outer circumference of the housing 50, which is adjacent to one end of the housing 50, while being perpendicular to the rotating axis of the housing, for sliding the first terminal body 10 as the housing 50 is rotated, and the second driving means may be a guide surface 15 formed at the inside of the first terminal body 10 for continuously contacting the rotary bar 51, as shown in FIGS. 3 and 5B.

The guide surface 15 is formed at the inside of the first terminal body 10 in such a manner that the rotary bar 51 contacts the guide surface 15 as shown in FIG. 5B. The first terminal body 10 is slid through the contact of the guide surface 15 and the rotary bar 51.

The guide surface 15 is formed in the shape of a smooth curved surface so that the rotary bar 51 can softly contact the guide surface 15 without interruption.

Also preferably, the first driving means may be a pinion 51′ securely fixed to the outer circumference of the housing 50, which is adjacent to one end of the housing 50, for sliding the first terminal body 10 as the housing 50 is rotated, and the second driving means may be a rack 15′ formed at the rear part of the first terminal body 10 such that the rack 15′ corresponds to the pinion 51′ for engaging with the pinion 51′, as shown in FIGS. 3 and 6A.

Also preferably, the first driving means may be a friction wheel 51″ securely fixed to the outer circumference of the housing 50, which is adjacent to one end of the housing 50, for sliding the first terminal body 10 as the housing 50 is rotated, and the second driving means may be a friction surface 15″ formed at the rear part of the first terminal body 10 such that the friction surface 15″ corresponds to the friction wheel 51″ for contacting the friction wheel 51″, as shown in FIGS. 3 and 6B.

As shown in FIG. 4, the housing 50 is rotatably disposed in the second terminal body 20, and the protrusion 45 of the guide cam 44 is fixed to one end of the second terminal body 20.

The sliding-type mobile communication terminal according to the present invention may further include a driving control unit (not shown) for controlling operation of the motor on the basis of a signal inputted to an opening/closing operation switch (not shown) for inputting information on whether the motor is operated or not and which direction the motor is operated in.

The opening/closing operation switch is used for accomplishing an automatic sliding movement. Specifically, the opening/closing operation switch is actuated by means of an actuating force of a user so that the driving means is operated by means of the opening/closing operation switch. When the user actuates the opening/closing operation switch, the opening/closing operation switch outputs a prescribed electric signal to the motor 31. The opening/closing operation switch is provided at one side of the terminal body of the mobile communication terminal in the form of a common on/off switch, although the opening/closing operation switch may be provided in various forms on the basis of the shape of the mobile communication terminal and the position where an actuating force of the user is easily applied. In this embodiment, the opening/closing operation switch is an exclusive switch for accomplishing the automatic sliding movement. However, it is also possible to use a button with different functions.

The forward/reverse operation of the driving means is controlled by means of the actuation of the opening/closing operation switch so that the second terminal body can be exposed while the second terminal body is covered, and the second terminal body can be covered while the second terminal body is exposed.

The driving control unit (not shown) is used to control an automatic or semiautomatic sliding movement. Specifically, the driving control unit (not shown) controls the operation of the motor on the basis of a signal from the opening/closing operation switch or a sensor unit, which will be described below.

The sliding-type mobile communication terminal has a slide module including guides for guiding a sliding movement so that the sliding movement can be stably accomplished, and sliders that perform a reciprocating sliding movement along the guides.

In the sliding-type mobile communication terminal with the above-stated construction according to the present invention, the slide module is mounted in the terminal body of he mobile communication terminal. Consequently, the sliding-type mobile communication terminal according to the present invention is provided with an aesthetically pleasing appearance. Furthermore, the assembly operation of the sliding-type mobile communication terminal is easily carried out since the parts are provided as housing modules disposed in the housing.

Preferably, the sliding-type mobile communication terminal according to the present invention further includes a sensor unit for controlling the sliding movement of the first terminal body 10. The driving control unit controls the operation of the motor 31 on the basis of a signal from the sensor unit.

More preferably, the sensor unit may include a sensor for directly detecting relative positions between the first terminal body and the second terminal body (a full opening position and a full closing position) or a sensor for detecting rotation of a prescribed part of the hinge shaft relative to the motor.

In order to perform the opening/closing operation of the sliding-type mobile communication terminal not only in the automatic/manual mode but also in the automatic/semiautomatic mode according to the selection of a user, it is preferable to provide all the above-mentioned sensors at the same time, which will be described in detail below with reference to the accompanying drawings.

First, a detailed description will be made of the sensor unit for directly detecting the relative positions between the first terminal body and the second terminal body (the full opening position/the full closing position) to recognize that the sliding movement has been completed.

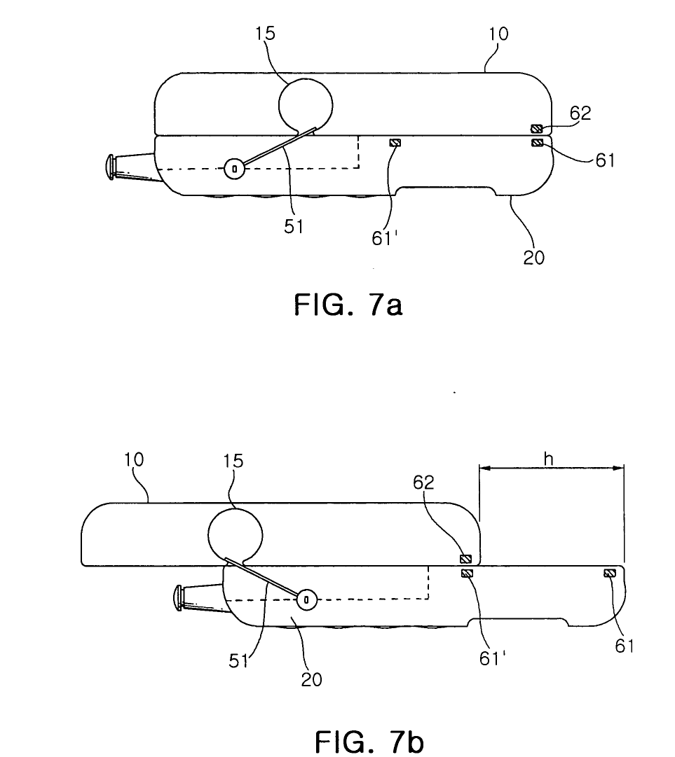

FIGS. 7A and 7B are side views respectively illustrating a fully closing/opening operation of the sliding-type mobile communication terminal with position detecting means for detecting whether the sliding movement is completed.

The driving motor is driven in order to automatically or semi-automatically operate the sliding-type mobile communication terminal. At this time, it is required to accurately operate the driving motor to the opening position and the closing position. To this end, the sensor unit as shown in FIGS. 7A and 7B is used in the sliding-type mobile communication terminal of the present invention.

The sensor unit comprises: a position detecting target 62 disposed at one of the first and second terminal bodies; and at least two position detecting means 61 and 61′ disposed at the other of the first and second terminal bodies such that the position detecting means 61 faces the position detecting target 62 when the first terminal body 10 is fully closed, i.e., the second terminal body 20 is fully covered, and the position detecting means 61′ faces the position detecting target 62 when the first terminal body 10 is fully opened, i.e., the second terminal body 20 is fully exposed.

The position detecting target 62 is detected through the switching between the position detecting means 61 or 61′ and the position detecting target 62, whereby the completion of the sliding movement of the first terminal body 10 is recognized.

The position detecting means 61 and 61′ and the position detecting target 62 are electrically connected to a control circuit (not shown) of the driving control unit that controls the operation of the motor 31. When the completion of the sliding movement is detected, the operation of the motor 31 is automatically stopped by means of the driving control unit so that the sliding movement can be automatically finished.

The above-mentioned at least two position detecting means 61 and 61′ are spaced apart from each other by a sliding distance h of the first terminal body 10 when the first terminal body 10 is opened and closed, i.e., a stroke of the first terminal body 10. Specifically, the position detecting means 61 is attached to the lower end of the first terminal body 10 at the position where the position detecting target 62 can be detected by means of the position detecting means 61 when the first terminal body 10 is fully closed, as shown in FIG. 7. The position detecting means 61′ is attached to the upper end of the first terminal body 10 at the position where the position detecting target 62 can be detected by means of the position detecting means 61′ when the first terminal body 10 is fully opened.

Preferably, each of the position detecting means 61 and 61′ may be a contact-type sensor that is switchable when the contact-type sensor contacts the position detecting target 62. The completion of the sliding movement of the first terminal body 10 is detected through the switching operation of the sensor.

More preferably, each of the position detecting means 61 and 61′ may be a switch terminal that is switchable by means of depression. The position detecting target 62 may be a contact terminal disposed in such a manner that the position detecting target 62 corresponds to each of the switch terminals and may be formed in the shape of a fine protrusion for pressing the corresponding switch terminal so that the switching operation is accomplished when the sliding movement of the first terminal body is completed.

Also preferably, each of the position detecting means 61 and 61′ may be a noncontact-type sensor that is switchable when the sensor faces the position detecting target 62 without the contact operation. The completion of the sliding movement of the first terminal body 10 is detected through the switching operation of the sensor.

In the case that the position detecting means 61 and 61′ are provided in the form of the noncontact-type sensors, it is required that the position detecting means 61 and 61′ of the first terminal body 10 be sensors that can be switched when a magnetic field is detected, and the position detecting target 62 of the second terminal body 20 be a magnet that generates the magnetic field. As the non-contact-type sensor, a hall sensor comprised of Hall IC's and a sensor using magneto-resistance effect elements (MR elements) may be used.

Alternatively, it is possible that the at least two detecting means 61 and 61′ are attached to the lower and upper ends of the second terminal body 20, respectively, and the position detecting target 62 is attached to the lower end of the first terminal body 10 in such a manner that the position detecting means 61 faces the position detecting target 62 when the first terminal body 10 is fully closed, i.e., the second terminal body 20 is fully covered, and the position detecting means 61′ faces the position detecting target 62 when the first terminal body 10 is fully opened, i.e., the second terminal body 20 is fully exposed.

Next, a detailed description will be made of a sensor unit for detecting prescribed-degree-rotation of a prescribed part of the hinge shaft 41 securely fixed to the shaft of the motor 31 to control the sliding movement.

The sensor unit may include a contact-type or noncontact-type sensor for detecting prescribed-degree-rotation of a prescribed part of the hinge shaft 41 relative to the motor 31 so that completion of the sliding movement is controlled.

In the case of the contact-type sensor unit, the sensor unit comprises: a brush housing 71 having outward-extending brushes; and a rectifying housing 72 having first and second patterns, as shown in FIGS. 4A and 4B. The first and second patterns are spaced apart from each other in such a manner that the first and second patterns are electrically connected to each other every 180 degrees through the electric connection with the brushes. As the motor 31 is rotated, the brush housing 71 and the rectifying housing 72 are rotated relative to each other. As a result, the first and second patterns are electrically connected to each other every 180 degrees by means of the brushes of the brush housing, by which a driving stop signal is applied to the driving control unit.

The shapes of the first and second patterns and the number of the brushes may be changed so that the first and second patterns are electrically connected to each other every prescribed degrees. In the case that the first and second patterns are electrically connected to each other at a phase of 360 degrees, for example, it is possible to electrically connect the first and second patterns to each other every 180 degrees through the use of two brushes.

In the case of the noncontact-type sensor unit, the sensor unit comprises: a detecting sensor switchable when a magnetic field is detected; and a magnet disposed in such a manner that the magnet corresponds to the detecting sensor for generating the magnetic field. As the motor is rotated, the detecting sensor and the magnet are rotated relative to each other. As a result, the detecting sensor and the magnet are opposite to each other without contact of the detecting sensor and the magnet every 180 degrees, and thus the detecting sensor and the magnet are switched, by which a driving stop signal is applied to the driving control unit.

The detecting sensor may be a hall sensor comprised of Hall IC's or a sensor using magneto-resistance effect elements (MR elements).

The above-mentioned contact-type or noncontact-type sensors may be attached to one side of the motor and one end of the hinge shaft opposite to the side of the motor. Alternatively, the contact-type or noncontact-type sensors may be attached to the tapered surface of the hinge shaft and the inside of the housing opposite to the tapered surface of the hinge shaft.

The sensor for detecting the 180-degree rotation of the prescribed part of the hinge shaft is very useful in the case that the first driving means is the rotary bar 51. In the case that the first driving means is the pinion 51′ or the friction wheel 51″, on the other hand, a sensor for detecting prescribed rotating degrees necessary for fully exposing and covering the second terminal body may be used.

The sliding-type mobile communication terminal with the above-stated construction according to the present invention can be operated in an automatic/semiautomatic mode or an automatic/manual mode depending upon the selection of a user. Specifically, the initial state of the semiautomatic operation is identical to the initial state of the manual operation as will be described below. Consequently, the semiautomatic or manual operation is decided on the basis of the user's selection. In the following description, the rotary bar 51 is adopted as the first driving means.

First, the principle of the automatic sliding movement of the sliding-type mobile communication terminal according to the present invention will be described with reference to FIGS. 4A and 7.

When a user presses the opening/closing operation switch (not shown) while the second terminal body 20 is covered, the driving control unit (not shown) determines whether the second terminal body is exposed or covered, and then the motor 31 is rotated in the direction in which the second terminal body 20 is exposed on the basis of a signal inputted from the opening/closing operation switch. Of course, the motor 31 is rotated in the opposite direction while the second terminal body 20 is exposed.

Determination as to whether the second terminal body is covered or exposed can be made by means of a circuit included in the mobile communication terminal, or the rotating direction of the motor is determined by means of the sensor unit for detecting the full closing and the full opening as shown in FIGS. 7A and 7B.

As shown in FIG. 4A, the protrusion 45 of the guide cam 44 is securely fixed to the second terminal body. As a result, the rotation of the guide cam 44 and the slide cam 42 disposed in the guide cam 44 is restricted. Also, the resilient force of the resilient means 43 is larger than the driving force of the motor. As a result, the resilient means 43 is not compressed by means of the operation of the motor, and thus the engagement of the slide cam 42 and the hinge shaft 41 is maintained.

Since the slide cam 42 is engaged with the hinge shaft 41 as described above, the rotation of the hinge shaft 41 is also restricted. Consequently, when the motor is operated, the main body of the motor is rotated, and thus the housing 50 securely fixed to the motor 31 is also rotated. As a result, the rotary bar 51 connected to the housing is rotated.

As the rotary bar 51 is rotated as described above, the rotary bar 51 contacts the guide surface 15 of the first terminal body 10 with the result that the first terminal body 10 is slid.

Completion of the sliding movement of the first terminal body 10, i.e., the full opening of the first terminal body 10, is detected by means of one of the above-mentioned sensor units.

In the case that the sensor for detecting the relative rotation between the hinge shaft 41 and the motor 31 is adopted, the sensor is switched when the prescribed part of the hinge shaft 41 is rotated prescribed degrees, by which the completion of the sliding movement of the first terminal body is detected. In the case that the sensor for detecting whether the second terminal body is fully covered or fully exposed is adopted, on the other hand, the completion of the sliding movement of the first terminal body is detected through the switching between the position detecting means 61′ and the position detecting target 62.

At this time, the driving control unit applies a driving stop signal to the motor 31 on the basis of the signal from the sensor unit.

The automatic sliding movement of the first terminal body for fully covering the second terminal body while the second terminal body is fully exposed is accomplished according to the same principle as the above-described automatic sliding movement of the first terminal body for fully exposing the second terminal body while the second terminal body is fully covered.

The present invention has an advantage in that the upper terminal body of the sliding-type mobile communication terminal can be more easily and smoothly opened and closed through the above-mentioned automatic sliding movement, as compared to the conventional mobile communication terminal in which the upper terminal body is slid only using the rack and pinion.

According to the present invention, a semiautomatic sliding movement is also possible according to a user's selection. In this case, the sensor unit having the position detecting means 61 and 61′ and the position detecting target 62 is adopted for directly detecting the relative positions between the first terminal body and the second terminal body to recognize the completion of the sliding movement.

When the user slides the first terminal body 10 in order to expose the second terminal body 20, the switching of the detecting means 61 and the position detecting target 62 is released as shown in FIG. 7A, whereby an OFF (Low) signal is generated.

At this time, the driving control unit recognizes the OFF signal, and thus the motor 31 is operated in the direction of exposing the second terminal body. The subsequent sliding operation is identical to that of the automatic sliding movement.

While the sliding movement is carried out so that the first terminal body is opened, the position detecting means 61′ and the position detecting target 62 are switched as shown in FIG. 7B, by which an ON (HIGH) signal is generated. As a result, the operation of the motor is stopped, and the semiautomatic sliding movement is finished.

When the first terminal body is slid so that the second terminal body 20 is covered, the sliding movement is carried out on the basis of the principle as mentioned above.

The manual sliding movement is also possible according to a user's selection.

The manual sliding movement of the mobile communication terminal according to the present invention will be described in detail below with reference to FIG. 4.

When a user pushes the first terminal body 10 while the first terminal body 10 is closed so that the first terminal body 10 is opened, an external force is applied to the rotary bar 51 through the contact of the rotary bar 51 and the guide surface 15 of the first terminal body 10. As the rotary bar 51 is rotated, the housing 50, to which the rotary bar 51 is securely fixed, is rotated, and the main body of the motor 31 securely fixed to the housing 50 is also rotated.

The geared motor 31 is not rotated as long as it is not operated. Consequently, the hinge shaft 41 is rotated along with the main body of the motor 31.

Also, the rotation of the guide cam 44 securely fixed to the second terminal body and the slide cam 42 disposed in the guide cam 44 is restricted, as described above. As a result, the hinge shaft 41 pushes the slide cam 42 in the direction indicated by an arrow shown in FIG. 4B by means of the rotation of the main body of the motor and the hinge shaft.

Consequently, the resilient means 43 is compressed, and the engagement of the hinge shaft and the slide cam is released, by which the first terminal body can be slid.

When the manual sliding movement is carried out, the rotation of the slide cam 42 is restricted, and the hinge shaft 41 is rotated along with the main body of the motor to push the slide cam in the axial direction. As a result, the resilient means 43 is compressed, by which an offset occurs.

The offset indicates that the engagement of the hinge shaft 41 and the slide cam 42 is released. When the rotary bar 51 is perpendicular to the slide surface, the offset angle is 90 degrees. As will be described below, a slight offset is present even when the first terminal body is fully closed or fully opened in order to resist a small external force.

When the offset angle is below 90 degrees, the first terminal body 10 is returned to its original position, i.e., in the direction in which the first terminal body 10 is closed, by means of a restoring force of the resilient means 43. When the offset angle is above 90 degrees, the first terminal body 10 is moved to the full opening position by means of the restoring force of the resilient means 43.

According to the present invention, the manual full opening or closing operation can be accomplished when an external force is applied to the sliding-type mobile communication terminal only once, and thus the sliding-type mobile communication terminal of the present invention can be more easily and smoothly opened/closed than the conventional sliding-type mobile communication terminal.

As described above, the manual sliding movement can be carried out according to the present invention. Especially, the sliding-type mobile communication terminal can be more smoothly opened or closed by virtue of the structure of the power transmission unit, as compared to the conventional sliding-type mobile communication terminal. Also, the first terminal body of the sliding-type mobile communication terminal can be returned to its original position by means of the restoring force of the resilient means.

Also, the first terminal body of the sliding-type mobile communication terminal according to the present invention can be returned to its original position when an external force is applied so that the first terminal body cannot be slid during the automatic or semiautomatic sliding operation.

When the second terminal body is not fully exposed since an external force is applied to the sliding-type mobile communication terminal, current is continuously supplied to the motor with the result that the battery is quickly consumed. Also, an excessive load is applied to a driving system of the sliding-type mobile communication terminal, which may result in breakdown of the sliding-type mobile communication terminal.

As described above, the automatic or semiautomatic sliding operation is carried out through the contact of the rotary bar 51 and the guide surface 15 of the first terminal body 10, which is accomplished by means of the operation of the motor 31, while the hinge shaft 41 is engaged with the slide cam 42.

When an external force is applied so that the first terminal body cannot be slid, the rotary bar is not rotated, and the motor is still rotated. As a result, an excessive load is applied to the motor, by which the hinge shaft 41 pushes the slide cam 42, and thus the engagement of the hinge shaft 41 and the slide cam 42 is released.

When the sensor unit that detects 180-degree rotation of the prescribed part of the hinge shaft is used in the case that the engagement of the hinge shaft 41 and the slide cam 42 is released as described above, the hinge shaft 41 is rotated since the engagement of the hinge shaft 41 and the slide cam 42 is released, and the sensor is switched. As a result, the sliding movement is completed. At this time, the first terminal body of the sliding-type mobile communication terminal is returned to its original position (the full opening position or the full closing position) as in the manual operation, although the offset occurs between the hinge shaft and the slide cam.

In the case that the completion of the sliding movement is detected by means of the sensor unit that detects the full opening and full closing of the first terminal body of the sliding-type mobile communication terminal, which comprises the position detecting means 61 and 61′ and the position detecting target 61, on the other hand, the completion of the sliding movement is not detected by means of the sensor unit. As a result, the motor is still operated. Even in the case that the sensor unit that detects the rotation of the prescribed part of the hinge shaft is used, the completion of the sliding movement may not be detected by means of the sensor unit when a very small external force insufficient to release the engagement of the hinge shaft and the slide cam is applied to the sliding-type mobile communication terminal.

When the completion of the sliding movement is not detected by means of the sensor unit as described above, a driving stop signal may be applied to the motor after a lapse of a prescribed period of time (s) so that the operation of the motor is stopped. When the operation of the motor is stopped in this way, an offset occurs as in the manual sliding operation.

When the offset angle is below 90 degrees, the first terminal body 10 is returned to its original position, i.e., in the direction in which the first terminal body 10 is closed, by means of a restoring force of the resilient means 43. When the offset angle is above 90 degrees, the first terminal body 10 is moved to the full opening position by means of the restoring force of the resilient means 43.

Preferably, the prescribed period of time (s) is one and a half times or two times as long as the time required for completing the sliding movement while no external force is applied to the sliding-type mobile communication terminal.

When an external force is applied to the sliding-type mobile communication terminal during the automatic or semiautomatic sliding movement as described above, the operation of the motor is stopped by means of the driving control unit so that the first terminal body can be returned to its original position by means of the restoring force of the resilient means.

The hinge shaft 41 is rotated 180 degrees relative to the motor until the sliding movement is completed. On the other hand, the rotary bar 51 is rotated less than 180 degrees until the sliding movement is completed.

It is established that the resilient means 43 is maximally compressed when the rotary bar 51 is perpendicular to the slide surface. Assuming that the rotating angle of the rotary bar 51 is 150 degrees, for example, an offset of 15 degrees occurs at the full opening position or the full closing position. Consequently, some of the compression force is retained in the resilient means.

The retained compression force prevents the opening/closing movement of the first terminal body of the sliding-type mobile communication terminal from being carried out by means of a very small external force applied to the first terminal body. Consequently, the sliding-type mobile communication terminal can be very stably used.

In the case that the first driving means is the pinion 51′ or the friction wheel 51″, it is required that the prescribed part of the hinge shaft be rotated above 180 degrees in order to carry out the automatic or semiautomatic sliding operation. Consequently, it is preferable to use the sensor unit for detecting rotation of the prescribed part of the hinge shaft by degrees necessary to fully open or fully close the first terminal body of the sliding-type mobile communication terminal.

Also, it is required that the prescribed part of the hinge shaft be rotated above 180 degrees. Consequently, it is preferable to engage the hinge shaft with the guide cam every 360 degrees. At this time, the critical angle for the manual sliding operation and the return to its original position is 180 degrees.

As apparent from the above description, the present invention provides an automatic/semiautomatic/manual sliding-type mobile communication terminal comprising a driving unit, a pair of engaging members, which are selectively engageable with each other, driving means, and a sensor unit so that a first terminal body and a second terminal body are easily and smoothly slid relative to each other in an automatic/semiautomatic/manual mode, whereby the sliding-type mobile communication terminal is more easily and smoothly opened/closed.

According to the present invention, the resilient means is used even when the manual sliding operation is carried out. Consequently, the sliding-type mobile communication terminal is more smoothly opened/closed, and can be returned to its original position.

Especially, the sliding-type mobile communication terminal of the present invention is provided with the sensor unit, by which the full opening and closing of the terminal body of the sliding-type mobile communication terminal can be accomplished when the sliding-type mobile communication terminal is automatically or semi-automatically operated. Furthermore, the opening/closing operation can be automatically completed when the terminal body of the sliding-type mobile communication terminal is not fully opened or closed due to an external force applied to the sliding-type mobile communication terminal.

In addition, the structure of the sliding-type mobile communication terminal according to the present invention is simple, and a slide mechanism is provided in the form of a housing module. Consequently, the assembly efficiency of the sliding-type mobile communication terminal is improved. Especially when the first driving means is a rotary bar, the sliding module can be mounted in the terminal body of the sliding-type mobile communication terminal, whereby the sliding-type mobile communication terminal is provided with an aesthetically pleasing appearance.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A sliding-type mobile communication terminal comprising:
a first terminal body and a second terminal body being slid relative to each other while one of the first terminal body and the second terminal body is laid on the top of the other;
a driving unit for providing power necessary for a sliding movement for opening/closing the mobile communication terminal;
a power transmission unit, having one end connected to a rotary shaft of the driving unit in the axial direction and the other end securely fixed to the second terminal body, for transmitting a driving force of the driving unit or an external force through a pair of engaging members selectively engageable with each other by resilient means;
a cylindrical housing rotatably mounted in the second terminal body, the housing receiving the power transmission unit therein, and fixing the driving unit therein so that a rotating axis of the housing is coaxial with the rotary shaft of the diving unit;
first driving means fixed to one side of the housing for sliding the first terminal body when the housing is rotated;
second driving means received in the first terminal body for contacting the first driving means so that the rotation movement of the first driving means is converted into the sliding movement of the first terminal body; and
a driving control unit for controlling operation of the driving unit so that the sliding movement of the first terminal body is controlled, and wherein
the housing is rotated through the rotational restriction of the power transmission unit and the selective engagement of the engaging members, and
the first driving means contacts the second driving means as the housing is rotated so that the sliding movement is carried out.

2. The mobile communication terminal as set forth in claim 1, wherein the driving unit comprises a geared motor with a gearbox for amplifying a driving torque.

3. The mobile communication terminal as set forth in claim 1, wherein the power transmission unit comprises:
a hinge shaft connected to the rotary shaft of the driving unit for transmitting the driving force of the driving unit;
a slide cam selectively engageable with the hinge shaft every prescribed degrees;
a guide cam for accommodating the slide cam; and
resilient means for providing a resilient force necessary to selectively engage the hinge shaft with the slide cam, and wherein
the pair of engaging members comprises the hinge shaft and the slide cam.

4. The mobile communication terminal as set forth in claim 3, wherein the guide cam has one end fixed to the second terminal body in a through-hole formed through the housing, and
the slide cam is disposed in the guide cam such that the slide cam can be relatively locked in the rotating direction and moved in the axial direction.

5. The mobile communication terminal as set forth in claim 3, wherein the resilient means is disposed between the slide cam and the guide cam to press the slide cam against the hinge shaft.

6. The mobile communication terminal as set forth in claim 3, wherein the hinge shaft and the slide cam are engaged with each other every 180 degrees.

7. The mobile communication terminal as set forth in claim 1, wherein the pair of engaging members are engaged with each other for an automatic or semiautomatic sliding operation so that the housing is rotated by means of the driving force of the driving unit fixed to the inside of the housing, and
the pair of engaging members are disengaged from each other for a manual sliding operation so that the housing is rotated by means of an external force applied to the first driving means.

8. The mobile communication terminal as set forth in claim 1, wherein
the first driving means is a rotary bar securely fixed to the outer circumference of the housing, adjacent to one end of the housing, while being perpendicular to the rotating axis of the housing, for sliding the first terminal body as the housing is rotated, and
the second driving means is a guide surface formed at the inside of the first terminal body for continuously contacting the rotary bar.

9. The mobile communication terminal as set forth in claim 1, wherein
the first driving means is a pinion securely fixed to the outer circumference of the housing, adjacent to one end of the housing, for sliding the first terminal body as the housing is rotated, and
the second driving means is a rack formed at the rear part of the first terminal body such that the rack corresponds to the pinion for engaging with the pinion.

10. The mobile communication terminal as set forth in claim 1, wherein
the first driving means is a friction wheel securely fixed to the outer circumference of the housing, adjacent to one end of the housing, for sliding the first terminal body as the housing is rotated, and
the second driving means is a friction surface formed at the rear part of the first terminal body such that the rack corresponds to the pinion for engaging with the friction wheel.

11. The mobile communication terminal as set forth in claim 1, wherein the driving control unit controls the operation of the driving unit on the basis of a signal from a sensor unit,
wherein the sensor unit comprises a position detecting target disposed at one of the first and second terminal bodies; and at least two position detecting means disposed at the other of the first and second terminal bodies such that each position detecting means corresponds to the position detecting target for detecting the position of the position detecting target to recognize the completion of the sliding movement,
and wherein the position detecting means are spaced apart from each other by a sliding distance of the first terminal body.

12. The mobile communication terminal as set forth in claim 11, wherein
each of the position detecting means is a contact-type sensor switchable when the position detecting means contacts the position detecting target, and
the completion of the sliding movement of the first terminal body is detected through the switching operation of the sensor.

13. The mobile communication terminal as set forth in claim 11, wherein
each of the position detecting means is a noncontact-type sensor switchable when the position detecting means is opposite to the position detecting target without contact, and
the completion of the sliding movement of the first terminal body is detected through the switching operation of the sensor.

14. The mobile communication terminal as set forth in claim 11, wherein the position detecting means applies a driving stop signal to the driving unit when the position detecting means does not detect the position detecting target for a prescribed period of time.

15. The mobile communication terminal as set forth in claim 1, wherein the driving control unit controls the operation of the driving unit on the basis of a signal from a sensor unit,
wherein the sensor unit comprises a contact-type or noncontact-type sensor for detecting that a prescribed part of the hinge shaft is rotated prescribed degrees relative to the driving unit to control the completion of the sliding movement.

16. The mobile communication terminal as set forth in claim 15, wherein the sensor unit comprises:
a brush housing having outward-extending brushes; and
a rectifying housing having first and second patterns spaced apart from each other such that the first and second patterns are electrically connected to each other every prescribed degrees through the electric connection with the brushes, and wherein
the first and second patterns of the rectifying housing are electrically connected to each other every prescribed degrees by means of the brushes of the brush housing as the brush housing and the rectifying housing are rotated relative to each other by means of the rotation of the driving unit, whereby a driving stop signal is applied to the driving control unit.

17. The mobile communication terminal as set forth in claim 15, wherein the sensor unit comprises:
a detecting sensor switchable when a magnetic field is detected; and
a magnet disposed such that the magnet corresponds to the detecting sensor for generating the magnetic field, and wherein
the detecting sensor is opposite to the magnet without contact, and thus the detecting sensor and the magnet are switched every prescribed degrees as the detecting sensor and the magnet are rotated relative to each other by means of the rotation of the driving unit, whereby a driving stop signal is applied to the driving unit.

18. The mobile communication terminal as set forth in claim 15, wherein the sensor unit applies a driving stop signal to the driving unit when the sensor unit does not detect that the prescribed part of the hinge shaft is rotated prescribed degrees for the prescribed period of time.

19. The mobile communication terminal as set forth in claim 1, wherein the driving control unit controls the operation of the driving unit on the basis of a signal from a sensor unit,
wherein the sensor unit comprises a position detecting target disposed at one of the first and second terminal bodies;
at least two position detecting means disposed at the other of the first and second terminal bodies such that each position detecting means corresponds to the position detecting target for detecting the position of the position detecting target to recognize the completion of the sliding movement; and
a sensor for detecting that a prescribed part of the hinge shaft is rotated prescribed degrees relative to the driving unit to control the completion of the sliding movement.
